(19) United States
(12) Patent Application Publication
(10) Pub. No.: US 2025/0345854 A1
(43) Pub. Date: Nov. 13, 2025

(54) HYBRID MANUFACTURING SYSTEM HAVING A COMMON ADDITIVE MANUFACTURING INTERFACE FOR USE WITH MODULAR ADDITIVE MANUFACTURING TOOLS

(71) Applicant: Additive Technologies LLC, Palm City, FL (US)

(72) Inventors: Brian Matthews, Palm Beach Gardens, FL (US); Chu-heng Liu, Penfield, NY (US); Paul J. McConville, Webster, NY (US); Sriram Manoharan, West Palm Beach, FL (US); Guy Morency, Chapel Hill, NC (US); Fredrik Perman, Raleigh, NC (US)

(21) Appl. No.: 18/659,917

(22) Filed: May 9, 2024

(51) Int. Cl. B22F 10/66; B22F 12/41; B22F 12/90; B33Y 30/00; B33Y 40/20

(52) U.S. Cl. CPC B22F 10/66; B22F 12/41; B22F 12/90; B33Y 30/00; B33Y 40/20

(57) ABSTRACT

A hybrid manufacturing system includes an additive manufacturing (AM) interface that mates with a plurality of modular AM tools to provide AM capabilities in a subtractive manufacturing system. The AM interface provides a common interface for delivering a plurality of resources to each of the modular AM tools. The AM tools are formed with multiple components, some of which can be used in different AM tools.

### STATEMENT REGARDING FEDERALLY FUNDED RESEARCH OR DEVELOPMENT

Not Applicable.

### TECHNICAL FIELD

This disclosure is directed to hybrid manufacturing systems that produce three-dimensional (3D) objects and, more particularly, to the incorporation of additive manufacturing devices in such systems.

### BACKGROUND

Machine tools, such as computerized numerical control (CNC) machines have been widely used to manufacture parts with a wide range of machining heads with different capabilities. These machining heads are typically called subtractive tools because they remove material from a material block to form a manufactured object. Technologies have been recently developed that produce manufactured objects by ejecting drops of a material or extrude ribbons of material. These technologies are called three-dimensional (3D) printing or additive manufacturing processes. These 3D additive manufacturing processes convert a digital model of a three-dimensional solid object into instructions that operate ejectors or extruders to form an object of virtually any shape. Many three-dimensional printing technologies use an additive process in which an additive manufacturing device forms successive layers of the part on top of previously deposited layers. Some of these technologies use ejectors that eject UV-curable materials, such as photopolymers or elastomers, while others eject melted metal drops from a reservoir within the ejector.

With the emergence and advancement of additive manufacturing technologies, machine tools have been developed that incorporate additive manufacturing capabilities to add material deposition and other additive manufacturing functions, such as object measurements, and in-process object modification. Subtractive tools typically only require precise spatial coordination and orientation of the tool relative to the part being formed and a motor to drive the tool. These requirements are met in current CNC machines with a spindle for holding the tools and a connector for holding and operating the tool.

Additive manufacturing (AM) components are much more complex than subtractive tools. For example, a laser deposition system requires connections to high level electric power, a source of inert shield gas, and sources of material supply, such as powder reservoirs or wire spools. The physical dimensions of various AM components also vary greatly and are typically much larger than those of subtractive tools. Consequently, most of the current subtractive manufacturing systems incorporate AM components with an ad-hoc approach. That is each AM component has its own customized resource connections and its own processing head. What is needed is a way to integrate AM components into a subtractive manufacturing system without unduly complicating the subtractive manufacturing system configuration.

### SUMMARY

A new hybrid manufacturing system incorporates AM tools into a subtractive manufacturing system in an integral manner. The new hybrid manufacturing system includes at least one subtractive tool connector; and an additive manufacturing (AM) tool interface configured to mate with a plurality of AM tools.

A new AM tool interface enables multiple types of AM tools to be incorporated within a subtractive manufacturing system. The new AM tool interface includes having a plurality of connections having first and second ends, the first ends of each connection in the plurality of connections being configured to receive resources from a plurality of resource supplies and the second ends of each connection in the plurality of connections being configured to deliver the received resources to an AM tool coupled to the AM tool interface.

### BRIEF DESCRIPTION OF THE DRAWINGS

The foregoing aspects and other features of a hybrid manufacturing system that uses an AM tool interface to incorporate multiple types of AM tools with a subtractive manufacturing system are explained in the following description, taken in connection with the accompanying drawings.

FIG. 1A is a side and bottom view of an AM tool interface that engages a subtractive tool connector.

FIG. 1B is a side and bottom view of an alternative embodiment of the AM tool interface shown in FIG. 1A that does not engage the subtractive tool connector.

FIG. 1C is a side view of an alternative embodiment of the AM tool interfaces shown in FIG. 1A and 1B that attaches to the subtractive manufacturing system at a position next to the subtractive tool connector.

FIG. 1D is a side view of an alternative embodiment of the AM tool interfaces shown in FIG. 1A, FIG. 1B, and FIG. 1C that is directly connected to the resource supplies.

FIG. 1E is a side view of an alternative embodiment of the AM interfaces shown in FIG. 1A, FIG. 1B, FIG. 1C, and FIG. 1D that includes a detachable connector for selectively connecting the AM tool interface of FIG. 1E to resource supplies.

FIG. 2 shows an active component that can be included in the interfaces shown in FIG. 1D and FIG. 1E.

FIG. 3 shows a generic model of a modular AM tool.

FIG. 4A depicts a support member holding modular components of an AM tool in association with a subtractive manufacturing system.

FIG. 4B depicts a wire fed laser deposition AM tool formed with two of the modular components shown in FIG. 4A and the connection of the assembled AM tool to an AM tool interface.

FIG. 5A shows a support member holding modular AM tool components and AM tool support components.

FIG. 5B shows an assembled melted metal drop ejector formed with two of the AM tool components shown in FIG. 5A and a reassembly of the AM tool and AM tool support components to maintain the operational status of the metal drop ejector.

### DETAILED DESCRIPTION

For a general understanding of the environment for the hybrid manufacturing system and its AM tool interface as disclosed herein as well as the details for the device and its operation, reference is made to the drawings. In the drawings, like reference numerals designate like elements. As used in this document, the term “hybrid manufacturing system” means a system having both subtractive tools and AM tools for forming manufactured objects. As used in this document, the term “subtractive manufacturing system” means a complete subtractive tool system, such as a known CNC machine. As used in this document, the term “subtractive tools” means any tool used by a subtractive manufacturing machine to remove material from material stock for formation of a manufactured object. As used in this document, the term “AM tool” means additive manufacturing devices that process and deposit materials onto an object being manufactured or measurement or object monitoring devices that acquire and process data for the object manufacturing process. As used in this document, the term “AM support tool” means a device configured to restore or maintain the operational status of an AM tool.

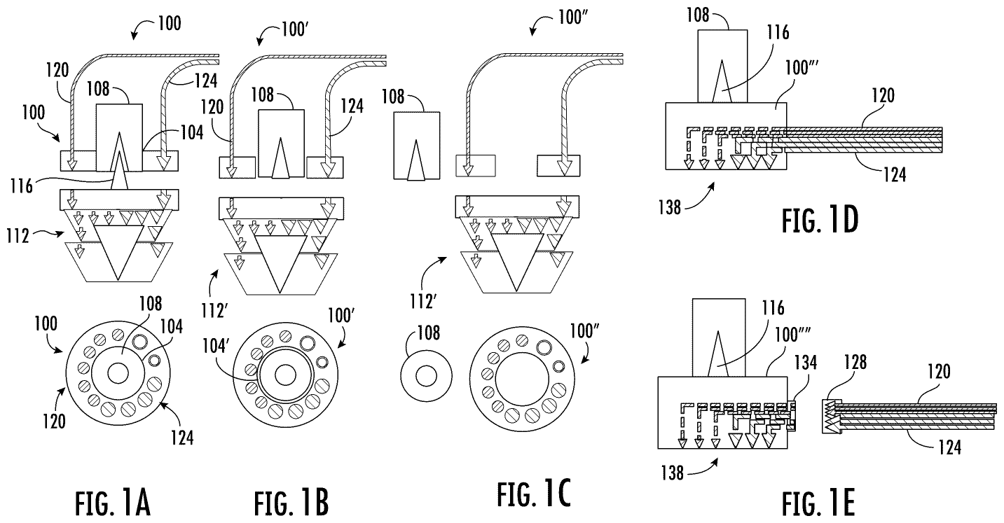

Various alternative embodiments of an AM tool interface that can be mounted to a subtractive manufacturing system are shown in FIG. 1A-FIG. 1E. In FIG. 1A, the AM tool interface 100 is a cylinder having an opening 104 that frictionally fits about a subtractive tool connector 108. Once the interface 100 is mounted about the connector 108, an AM tool 112 that includes a spindle 116 configured to engage the connector 108 can be installed in the subtractive manufacturing system. The bottom view depicted in FIG. 1A does not include the AM tool 112 so the connector 108 is shown as being empty. Connections 120 and 124 are conduits, cables, insulated electrical wires, gas lines, and the like that bring resources from external supplies (not shown) to the interface 100 and the AM tool 112 has corresponding connections to the output ports of the connections 120 and 124 so the resources that pass through the interface 100 can be fed to the AM tool 112. As used in this document, the term “resources” refers to materials and energies required for operation of the AM tools connected to an AM tool interface. Such material and energies include, but are not limited to: electrical power, optical energy, such as lasers and curing radiation, inert gas, compressed air, a vacuum, liquids, materials, such as metal powders, metal wires, or metal rods, electronic connections for electrical busses, USB, and heat, such as hot air or heated liquids.

Using the same or similar reference numbers, the remaining embodiments of the AM tool interfaces in FIG. 1B to FIG. 1E differ in the position and manner of connection of the interface to the subtractive manufacturing system and the permanence of the connections to the external sources. In FIG. 1B, the AM tool interface 100′ does not frictionally fit around connector 108 since it has a larger diameter opening. Instead, this tool interface is mounted to the subtractive tool system. The interface 100″ is secured to the subtractive manufacturing system at a location that is adjacent the connector 108 by attaching the interface to the frame of the tool system. The interfaces 100″′ and 100″″ shown in FIG. 1D and FIG. 1E, respectively, include a spindle 116 that is configured to mate with the connector 108 to secure these interfaces to the subtractive manufacturing system. The connections 120 and 124 have input ends (not shown) and output ends 138 so the connections 120 and 124 physically enter the interface 100″′ and mate with an AM tool at the output connections 138. The interface 100″″ includes an input hub 134 and all of the output ends of the connections 120 and 124 terminate at output ports in connector 128. Connector 128 can be selectively mounted to the input hub 134 to provide resources from the supplies (not shown) to the output connections 138.

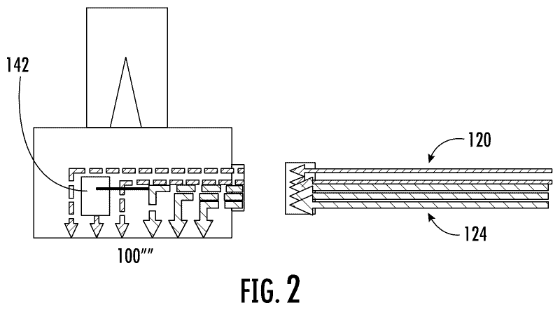

In comparison of the various interfaces, the interfaces in FIG. 1A, FIG. 1D, and FIG. 1E are mounted in association with the subtractive tool connector 108 so they can take advantage of the orientation and positioning system of the subtractive manufacturing system. The connections 120 and 124 of all of the interface embodiments shown in these figures are permanently installed to the output ports 138 except the embodiment shown in FIG. 1E. As noted above, that embodiment has an input hub 134 that enables selective mating with the output ends of the connections 120 and 124. FIG. 2 shows an alternative embodiment of the interface 100″ that includes an active component 142, such as a micro-compressor, a micro-pump, or a heating element, to produce a compressed gas, vacuum, or heat for use by an AM tool installed to the interface. Such an alternative embodiment can be utilized in the interface 100″′ as well.

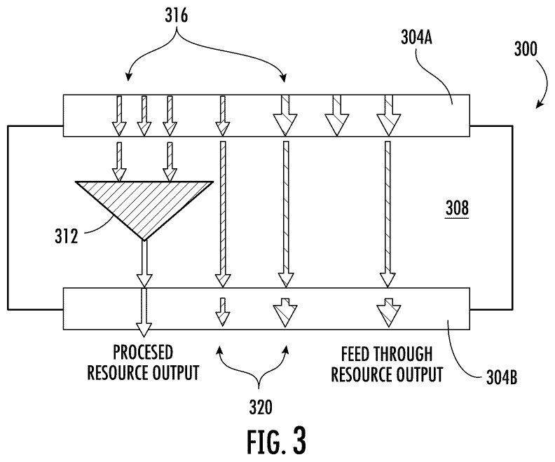

The AM tools that best interface with the subtractive manufacturing system using the AM tool interfaces described above are modular. That is, they are comprised of component parts that are assembled to form the AM tool that is mated to the AM tool interface. As used in this document, the term “modular AM tool” refers to a device used for additive manufacturing that has multiple components that can be assembled within a hybrid manufacturing system to mate with an AM tool interface. A generic model 300 of these AM tools is depicted in FIG. 3. The AM tool 300 receives resources from the resource supplies connected to the AM tool interface. The AM tool 300 is configured with input ports 316 in an input interface 304A that mate with one or more of the connections 138 of an AM tool interface. Some of these input ports 316 mate directly with output ports 320 in an output interface 304B to permit AM tool resources to flow through the AM tool while one input port in the figure is depicted as not permitting the connected resource to flow through the AM tool. One or more input ports 316 may be connected to an active processing device 312 to produce a processed resource that is provided to an output port 320 for use in the additive manufacturing process. For example, the active processing device 312 can be an electrical heater having a reservoir that receives a metal wire and an electrical signal. The electrical signal is connected to the heater to operate the heater and melt the wire so melted metal is formed in the reservoir. This melted metal can then be ejected onto an object being constructed. The space 308 is shown in the figure to facilitate the discussion of the active processing device.

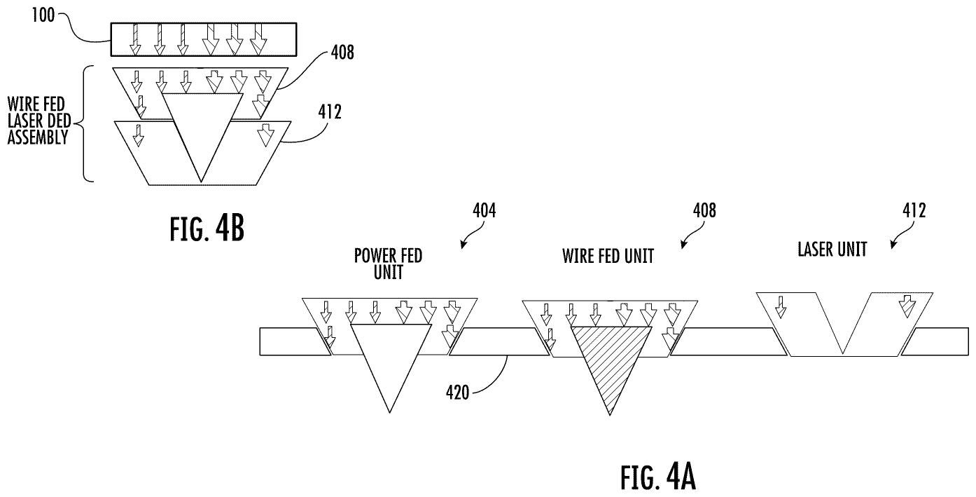

As shown in FIG. 4A, modular components of AM tools can be stored on a support member 420, such as a conventional carousel changer in known subtractive manufacturing systems. Modular component 404 is a metal powder unit of a laser deposition head, modular component 408 is a wire fed unit of a laser deposition head, and modular component 412 is a laser unit. As shown in FIG. 4B, the wire fed unit 408 has been moved from the support member 420 to mate with the AM tool interface 100 and the laser unit 412 has been mated to the wire fed unit 408 to form a wire fed laser deposition head. Alternatively, the metal powder unit 404 can also be connected to the AM tool interface 100 and the laser unit 412 mated to the metal powder unit 404 to form a powder fed laser deposition head. This ability to form different types of AM tools with modular components facilitates the use of AM tools with subtractive manufacturing systems in a manner that is better than the ad hoc approach used in previously known systems.

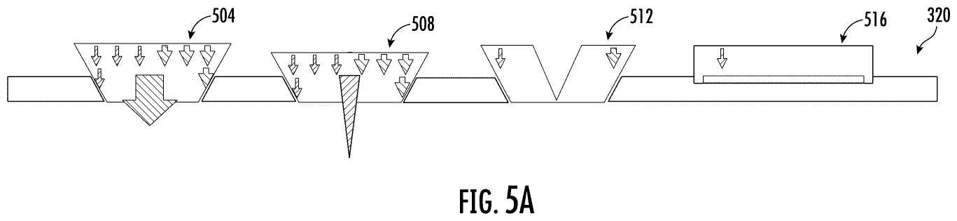

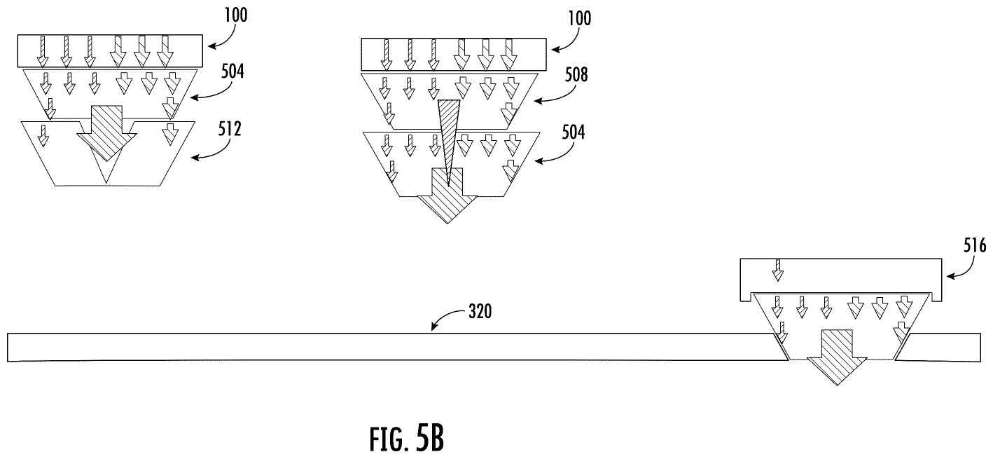

FIG. 5A and FIG. 5B demonstrate another advantage arising from the modular construction of the AM tools. In FIG. 5A, the support member 320 holds a melted metal drop ejector 504, a dross removal tool 508, an instrumentation unit 512, and an inert gas sealer 516. The melted metal drop ejector 504 is configured to receive solid metal from one of the input ports, melt the solid metal, and pulse an electrical signal through an electrical coil wound about a reservoir in which the solid metal is ejected to eject melted metal drops through one of the output ports. The instrumentation unit 512 includes devices, such as an optical sensor, a height/distance measurement device, a temperature sensor, and the like that are used to monitor the object being manufactured. The optical sensor is configured to generate image data of the object being manufactured and this image data can be provided through the AM tool interface to an external processor for evaluation of the object manufacturing process. The height/distance sensor generates measurements of the top surface of a layer while the part is being built. Preferably, the height/distance sensor is a non-contact device, such as a laser triangulation sensor. A controller of the hybrid manufacturing system being configured with programming instructions stored in a non-transitory computer readable media that, when executed by the controller, cause the controller to form a 3D surface profile of the top surface of a part layer with the height/distance data and compare it to a digital model of the part so a corrective process can be initiated if the error between the measurements and the model exceeds a predetermined threshold. The signal generated by the temperature sensor of the object being manufactured is used within the active processing device to regulate the ejection of the melted metal drops. The unit 512 can also include a laser that is operated to remediate a portion of the object that did not form correctly. The inert gas sealer 516 includes an input port for receiving an inert gas and filling a plenum in the sealer with the inert gas. The plenum is configured to mate with portion of the ejector 504 populated with the input ports to prevent the ingress of ambient air into the ejector 504.

As shown in FIG. 5B, the melted metal drop ejector 504 can be mated to the AM tool interface 100 and the instrumentation unit 512 connected to the ejector 504 to form a melted metal drop ejector AM tool. After use of the tool, the instrumentation unit 512 and the ejector 504 can be disconnected and returned to the support member 320 and then the dross removal tool 508 can be mated to the AM tool connector 300. The ejector 504 is then mated to the dross removal tool 508 for removal of metal dross from the ejector. Following dross removal, the ejector 504 is returned to the support member 320 and the inert gas sealer 516 is pressed over the interface to the ejector 504 to preserve the clean status of the ejector and the dross removal tool 508 can also be returned to the support member 320. Again, the modularity of the AM tool and support tool components facilitates their use and support with the subtractive manufacturing system.

It will be appreciated that variants of the above-disclosed and other features and functions, or alternatives thereof, may be desirably combined into many other different systems, applications or methods. Various presently unforeseen or unanticipated alternatives, modifications, variations or improvements may be subsequently made by those skilled in the art that are also intended to be encompassed by the following claims.

What is claimed:

1. A hybrid manufacturing system comprising:
at least one subtractive tool connector; and
an additive manufacturing (AM) tool interface configured to mate with a plurality of AM tools.

2. The hybrid manufacturing system of claim 1 wherein the AM tool interface includes an opening and frictionally engages the at least one subtractive tool connector.

3. The hybrid manufacturing system of claim 1 wherein the AM tool interface includes an opening that fits around the at least one subtractive tool connector without engaging the at least one subtractive tool connector.

4. The hybrid manufacturing system of claim 1 wherein the AM tool interface is configured to be installed adjacent to the at least one subtractive tool connector.

5. The hybrid manufacturing system of claim 1, the AM tool interface further comprising:
a spindle configured to be installed into the at least one subtractive tool connector.

6. The hybrid manufacturing system of claim 5, the AM tool interface further comprising:
a plurality of connections having first and second ends, the first ends of each connection in the plurality of connections being configured to receive resources from a plurality of resource supplies and the second ends of each connection in the plurality of connections being configured to deliver the received resources to an AM tool coupled to the AM tool interface.

7. The hybrid manufacturing system of claim 5, the AM tool interface further comprising:
an input hub configured to mate selectively with a plurality of connections that are configured to receive resources from a plurality of resource supplies, the input hub being configured to deliver the received resources to an AM tool coupled to the AM tool interface.

8. The hybrid manufacturing system of claim 1 further comprising:
an AM tool, the AM tool having at least one input port, at least one output port, and at least one active processing device, the at least one active processing device being configured to receive a resource from the at least one input port and process the received resource to produce a processed resource that is delivered through the at least one output port to a part being manufactured by the hybrid manufacturing system.

9. The hybrid manufacturing system of claim 8 wherein the at least one active processing device receives solid metal from the at least one input port and melts the solid metal to form melted metal that is delivered through the at least one output port to the part being manufactured by the hybrid manufacturing system.

10. The hybrid manufacturing system of claim 9, the at least one active processing device further comprising:
a wire fed component configured to receive solid metal wire from the at least one input port; and
a laser component to melt the solid metal wire after the solid metal wire has exited the at least one output port.

11. The hybrid manufacturing system of claim 9, the at least one active processing device further comprising:
a metal powder fed component configured to receive solid metal powder from the at least one input port; and
a laser component to melt the solid metal powder after the solid metal wire has exited the at least one output port.

12. The hybrid manufacturing system of claim 9, the at least one active processing device further comprising:
a reservoir configured to hold melted metal; and
an electrical coil wound around the reservoir to enable an electrical signal through the electrical coil to eject melted metal drops from the active processing device.

13. The hybrid manufacturing system of claim 12, the AM tool further comprising:
an instrumentation unit configured to monitor an object being manufactured with the AM tool.

14. The hybrid manufacturing system of claim 12, the instrumentation unit further comprising:
an optical sensor configured to generate image data of the object being manufactured by the AM tool.

15. The hybrid manufacturing system of claim 14, the instrumentation unit further comprising:
a laser configured to direct laser radiation onto a surface of the object being manufactured by the AM tool.

16. The hybrid manufacturing system of claim 12, the instrumentation unit further comprising:
a temperature sensor configured to generate a signal corresponding to a temperature of the surface of the object being manufactured by the AM tool.

17. The hybrid manufacturing system of claim 8, the AM tool further comprising:
an input port configured to receive an inert gas;
a plenum configured to mate with an input interface of a melted metal drop ejector having a plurality of input ports, the plenum being fluidly connected to the input port to receive the inert gas.

18. The hybrid manufacturing system of claim 17, the AM tool further comprising:
a dross removal tool configured to mate with the input interface of a melted metal drop ejector having a plurality of input ports to remove metal dross from the melted metal drop ejector.

19. The hybrid manufacturing system of claim 12, the instrumentation unit further comprising:
a height/distance sensor configured to generate measurements corresponding to a an exposed layer of the part being manufactured by the hybrid manufacturing system.

20. The hybrid manufacturing system of claim 19 further comprising:
a controller configured to form a 3D surface profile of a the part being manufactured by the hybrid manufacturing system with the measurements generated by the height/distance sensor and initiate a corrective action in response to a comparison of the 3D surface profile to a digital model of the part exceeding a predetermined threshold.
